(19) United States
(12) Patent Application Publication
(10) Pub. No.: US 2009/0048923 A1
(43) Pub. Date: Feb. 19, 2009

(54) ANCHOR MERCHANT PROGRAM PROXIMATE VENDOR SYSTEMS AND PRODUCTS THEREBY

(76) Inventors: Charles Seven, Newport Beach, CA (US); Ryan Seven, Newport Beach, CA (US); Stuart Graham, Newport Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/179,519

(22) Filed: Jul. 24, 2008

Related U.S. Application Data
(60) Provisional application No. 60/951,686, filed on Jul. 24, 2007.

(51) Int. Cl. G06Q 30/00; G06Q 20/00

(52) U.S. Cl. 705/14

(57) ABSTRACT

A method and system for promoting customer loyalty to an anchor business within a certain geographical region from a plurality of participating merchants. The system having a server configured to store data including an identifier associated with a customer account in a customer rewards program. The server may receive the data and purchase transaction amount from a merchant terminal, verify a customer's membership in the customer rewards program, and transfer an award associated with the purchase transaction amount to the customer account. Additionally, the server may process customer's directive for redeeming the award for use at the anchor business. In another embodiment, the server may store a promotional program offering a value-bearing instrument for a participating merchant, provide the promotional program through an anchor business website, receive request code to purchase the value-bearing instrument, and transfer an award associated with the purchase of the value-bearing instrument to the customer account.

### RELATED APPLICATION

This application claims the benefit of and priority to U.S. Provisional Application Ser. No. 60/948,943, filed Jul. 10, 2007, U.S. Provisional Application Ser. No. 60/948,937, filed Jul. 10, 2007, and U.S. Provisional Application Ser. No. 60/951,686, filed Jul. 24, 2007, the contents of which each are incorporated by reference herein in its entirety.

### BACKGROUND

The present disclosure relates generally to customer rewards methods and systems, and more specifically, to a method, system and products thereby for promoting customer loyalty to an anchor business within a certain geographical region from a plurality of participating merchants.

### SUMMARY

A system for promoting customer loyalty to an anchor business within a certain geographical region from a plurality of participating merchants is provided. The system may include a memory and a processor. The memory stores a data including at least an identifier associated with a customer account in the customer rewards program. The processor may be configured to receive the data and a purchase transaction amount from a merchant terminal located at one of the plurality of participating merchants. The processor may verify a customer's membership in the customer rewards program from the received data. The processor may also charge or debit the one of the plurality of participating merchants a certain percentage of the purchase transaction amount. The processor may then transfer an award associated with the purchase transaction amount to the customer account. The award may be a fraction of the certain percentage charged to the one of the plurality of participating merchants. The award may be a dollar amount, a cash value and a credit point. The processor may be configured to accumulate, in the customer account, additional awards associated with other purchase transactions amounts. In one embodiment, the processor may then process a customer's directive for redeeming the award for use at the anchor business.

In one embodiment, the memory may be used to store a promotional program for the one of the plurality of participating merchants. The promotional program may be specific to one participating local merchant or it may be general and not customized for use at any of the plurality of participating merchants. The promotional program may offer a value-bearing instrument with a face value greater than its sale value. The value-bearing instrument may be used at the one of the plurality of participating merchants. In this embodiment, the processor may be configured to provide the promotional program through an anchor business website, receive an election of the one of the plurality of participating merchants through the anchor business website, receive an election of the face value for the value-bearing instrument, and receive a request code to purchase the value-bearing instrument.

According to a feature of the present disclosure, a computer-implemented method for promoting customer loyalty in a customer rewards program to an anchor business within a certain geographical region from a plurality of participating merchants is disclosed. The computer-implemented method may include storing a data including at least an identifier associated with a customer account in the customer rewards program, receiving the data and a purchase transaction amount from a merchant terminal located at one of the plurality of participating merchants, verifying a customer's membership in the customer rewards program from the received data, transferring an award associated with the purchase transaction amount to the customer account, and processing a customer's directive for redeeming the award for use at the anchor business.

The computer-implemented method may further include accumulating, in the customer account, additional awards associated with other purchase transactions amounts. In one embodiment, the computer-implemented method may also include charging the one of the plurality of participating merchants a certain percentage of the purchase transaction amount, after the step of receiving the data and a purchase transaction amount from a merchant terminal. Additionally, the computer-implemented method may include storing, in an anchor business database, a promotional program for the one of the plurality of participating merchants, providing the promotional program through an anchor business website, and receiving a request code to purchase the value-bearing instrument. In one embodiment, the computer-implemented method may also include receiving an election of the one of the plurality of participating merchants through the anchor business website, and receiving an election of the face value for the value-bearing instrument prior to the step of receiving a request code to purchase the value-bearing instrument.

According to a feature of the present disclosure, a machine-readable medium is disclosed. The machine-readable medium provides instructions, which when read by a processor, cause the machine to perform operations including storing a data including at least an identifier associated with a customer account in the customer rewards program, storing a promotional program for at least one participating merchant, receiving the data from a customer computer through an anchor business website, verifying a customer's membership in the customer rewards program from the received data, providing the promotional program through the anchor business website, receiving a request code to purchase the value-bearing instrument, transferring an award associated with the purchase of the value-bearing instrument to the customer account, and processing a customer's directive for redeeming the award for use at the anchor business. In one embodiment, the machine-readable medium may also provide instructions, which when read by a processor, cause the machine to perform operations including receiving an election of the one of the plurality of participating merchants through the anchor business website, and receiving an election of the face value for the value-bearing instrument prior to the step of receiving a request code to purchase the value-bearing instrument.

### DRAWINGS

The above-mentioned features and objects of the present disclosure will become more apparent with reference to the following description taken in conjunction with the accompanying drawings wherein like reference numerals denote like elements and in which:

FIG. 1 schematically illustrates a customer rewards system, according to one embodiment of the present disclosure.

FIG. 2 is an exemplary flowchart outlining the operation of an anchor business server for promoting customer loyalty to an anchor business, according to one embodiment of the present disclosure.

FIG. 3 is an exemplary flowchart outlining the operation of an anchor business server for providing promotional programs of participating merchants within a certain geographical region from an anchor business, according to an embodiment of the present disclosure.

FIG. 4 is an exemplary flowchart outlining the operation of an anchor business server for promoting customer loyalty to an anchor business while providing promotional programs of participating merchants within a certain geographical region from the anchor business, according to an embodiment of the present disclosure.

### DETAILED DESCRIPTION

In the description that follows, the present invention will be described in reference to preferred embodiments for customer rewards methods, systems and products thereby. The present invention, however, is not limited to any particular application nor is it limited by the examples described herein. Therefore, the description of the embodiments that follow are for purposes of illustration and not limitation.

The customer rewards system may be used to provide patrons of an anchor business, such as a large supermarket or movie theater, with the ability to accumulate and redeem an award at the anchor business, such as loyalty points, by shopping at participating merchants within a certain geographic region from the anchor business. Through an enhanced customer loyalty program, the anchor business may promote and advertise for the neighboring merchants to patrons of the anchor business. A fraction of the purchase transaction amount at a participating merchant may then be used as an award that accumulates in a customer's account and redeemable at the anchor business.

Nearly every supermarket offers some kind of loyalty card. When a customer shops at the store with the card, the customer receives special discounts on selected items. Unfortunately, because everyone offers them, many consumers have three or four grocery cards and they still shop based on distance/convenience, not loyalty. The customer rewards program of the present invention may provide a significant difference to at least one major grocery chain in each city. The customer rewards program of the present invention may provide a ‘competitive advantage’ for at least one grocery over its/their competition. The possibility of “free” groceries is an overwhelming value proposition for consumers.

According to one embodiment, the customer rewards program may utilize a rewards card having at least an identifier, such as a BIN number, that enables the card to ride on a major network rail. The anchor business may issue these rewards cards at the store or online to its patrons. In one embodiment, the anchor business need not eliminate its existing rewards cards. The same cards may be used for the customer rewards program of the present invention.

As is understood by a person skilled in the art, any means of customer identification may be used other than a rewards card, such as, but not limited to, radio frequency ID, hologram, fingerprint, voice print, retina print, Bluetooth or any other electronic or biometric method of identification.

Local merchants living off the traffic from the anchor business may then be invited to participate in the customer rewards program of the present invention. In one embodiment, the local merchants are within a certain geographical region from the anchor business, such as, but not limited to, at least about 1 mile to about 5 mile radius and may extend to about 30 mile radius around the anchor business. Through the customer rewards program of the present invention, the participating merchants may be promoted through the anchor business with flyers and ad tags, through an anchor business website, and the like.

When a customer makes a purchase at a participating merchant, the customer may pay with cash, check or credit card. The customer may present his/her value-bearing instrument, such as the rewards card, to the participating merchant. The rewards card may be swiped at a merchant terminal, such the merchant's existing credit card terminal. As can be appreciated by a person skilled in the art, the merchant may not need any special equipment, software or processor co-operation. The merchant terminal may transmit the identifier associated with the rewards card and a customer account in the customer rewards program. The merchant terminal may also transmit a purchase transaction amount to the anchor business server or a third party server, such as a bank or a third party company facilitating the customer rewards program for the anchor business.

In one embodiment, the anchor business or the third party company may confirm the purchase transaction amount with the participating merchant. The anchor business or the third party company may then charge or debit the participating merchant a certain percentage of the purchase transaction amount, for example, 10% of the purchase transaction amount as a fee for participating in the customer rewards program. A fraction of the certain percentage is transferred to the customer account as an award, while the remainder or balance may be deducted as a fee for administering the customer rewards program by the anchor business or the third party company. The customer may redeem the award, for example, a dollar amount, a cash value or a credit point, at the anchor business.

As can be appreciated by a person skilled in the art, the customer or patron of the anchor business receives “free groceries” by redeeming the award transferred and accumulated in the customer account. The award is funded by the local participating merchants who benefit from the traffic from the anchor business. The local merchant gets much needed promotion and only pays for performance. The anchor business may get millions of dollars of money that is forced through its doors and creates real loyalty. The anchor business promotes the customer rewards program to its patrons and distributes the value-bearing instruments. The value-bearing instruments, such as the rewards cards, may be paid for by the anchor business or the third party company administrator.

The third party company administering the customer rewards program also makes money every time a purchase transaction is made. For example, in a city with 20 participating anchor businesses with an average of 10,000 shoppers per anchor business, a participation rate of 23% and an average monthly spend of $100 at the local participating merchants would generate $1,200,000 per year for the third party administrator from that city.

According to one embodiment, promotional programs for participating merchants may be displayed on an anchor business website, as an alternative rewards program to or apart of the customer rewards program. The promotional program may offer a value-bearing instrument with a face value greater than its sale value, that can be used at one of the participating merchants. For example, the promotional program may be a gift certificate for use at a participating merchant. Since this rewards program is web-based, customers may be instructed and encouraged to visit the anchor business website. As used herein, the anchor business website may be any website administered or controlled by the anchor business or by any third party administering the customer rewards program.

The anchor business may promote this rewards program to its patrons. Local merchants living off the traffic from the anchor business may then be invited to participate in this rewards program. The customer may visit the anchor business website and choose one of the participating merchants they want along with the face value of value-bearing instrument they want. The customer may then pay for the value-bearing instrument for use at the selected participating merchant. In one embodiment, the customer may then print the certificate from his/her local computer.

As can be appreciated by a person skilled in the art, the customer may log on to the customer account via the anchor business website, select a value-bearing instrument for a participating merchant, and pay for the value-bearing instrument. An award associated with the purchase transaction of the value-bearing instrument may then be transferred to the customer account and is redeemable at the anchor business.

The participating merchant agrees to honor the value-bearing instrument purchased from the anchor business website. For example, the participating merchant may agree to honor one value-bearing instrument per customer per month. As can be appreciated, a customer may buy a ‘$50 certificate’ from the anchor business website for $18. A fraction of the value of the certificate may be transferred as an award in the customer account. For example, 30% of the purchase value, $5.40, is transferred to the customer account. The customer may then make a $100 purchase at the participating merchant, present the ‘$50 certificate’ and pay $50 with cash, check or credit card. The customer would, in this example, realize an immediate savings of $34. In one embodiment, 10% of the purchase transaction amount may be deducted from the participating merchant (i.e. $10), in which case a fraction is transferred to the customer account (i.e. $5) and the remainder is charged as an administration fee (i.e. $5). Hence, the customer realizes an additional $5, in this example, that can be redeemed at the anchor business.

As is understood by a person skilled in the art, the customer rewards program utilizing the rewards card (also referred to herein as “first customer rewards program”) may require an Automated Clearing House (ACH) for electronic funds transfer (EFT) system from the participating merchant, while the rewards program for purchasing a value-bearing instrument (also referred to herein as “second customer rewards program”) may not require the ACH from the participating merchant. The first customer rewards program may not require the use of an anchor business website, while the second customer rewards program may require the anchor business website to purchase the value-bearing instruments. A customer using the rewards card may not realize immediate savings for the first customer rewards program, while a customer using the purchased value-bearing instrument of the second customer rewards program does realize immediate savings when presenting the value-bearing instrument to a participating merchant. The first customer rewards program may also require a customer account, while the second customer rewards program may not require a customer account. Additionally, a customer may be required to present the rewards card to the participating merchant of the first customer rewards program, while a customer may be required to present the value-bearing instrument purchased from the second customer rewards program.

As can be appreciated, the customer rewards program of the present disclosure may also be used with movie theaters. Like grocery stores, movie theaters are highly motivated to reward their customers for coming to the theater, especially with increasing competition from Pay Per View, Blockbuster and latest in High Definition Technology taking the customers away from theaters. Many theaters have even added restaurants in the lobbies to entice movie fans to their cinema location. National Amusement and Regal Theatre Group currently utilize a rewards program that offers free popcorn or movie after the patrons spend hundreds of dollars on movie tickets requiring as many as 25 to 35 visits for free movie reward.

The customer rewards program of the present disclosure may be used with movie theaters to accumulate and redeem an award at the theater, such as loyalty points, by shopping at participating merchants within a certain geographic region from the movie theater. Through an enhanced customer loyalty program, the movie theater may promote and advertise for the neighboring merchants to the patrons of the theater. A fraction of the purchase transaction amount at a participating merchant may then be used as an award that accumulates in a customer's account and redeemable at the theater for free tickets and concessions. In one embodiment, the theater uses its central location and the power of its advertising on the screen and in the lobbies to drive theater goers to area merchants participating in the customer rewards program.

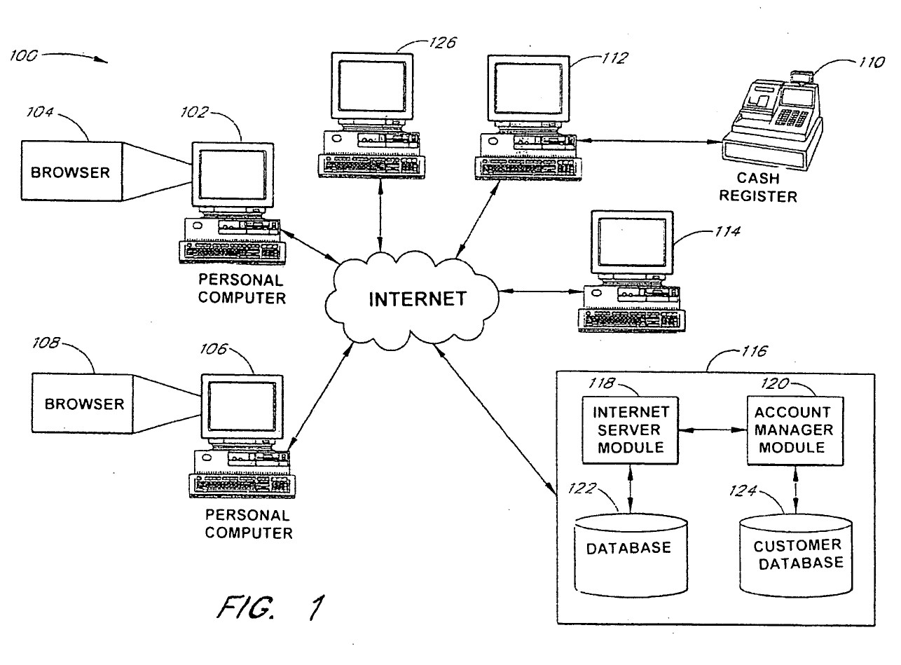

FIG. 1 illustrates exemplary basic hardware and/or software modules used to implement one or more embodiments of the customer rewards system 100. As illustrated, customers may access the anchor business server 116 for the second customer rewards program using respective personal computers, 102, 106 or other terminals, such as phone and personal digital assistants, that have access to a network, such as the Internet. The customer computers 102, 106 may run commercially-available Web browser applications 104, 108 such as Microsoft Internet Explorer®, which implements World Wide Web standards such as HTTP, HTML, XML, Java, Flex, Ajax and the like.

The merchant computer 112 and the third party administrator computer 114 may be implemented using mainframe computers, minicomputers, personal computers, servers, and the like. The merchant computer 112 may be networked or otherwise coupled to a point-of-sale merchant terminal or register 110. Information related to a purchase may be relayed from the merchant computer 112 to the anchor business server 116 over the Internet, private network, or using other techniques for transferring digital data, such a magnetic tape. The information may be relayed in real-time, or periodically, such as once a day. In one embodiment, the information may include at least an identifier associated with a customer account in the customer rewards program. Dollar amount, cash value or credit points may then be transferred to and/or accumulated in the customer account.

The anchor business server 116 may include a computer server system and software modules, as well as associated content that may be accessible using the Internet. The anchor business server 116 may use a commercially-available Internet server module 118 which accesses a database 122 that may be used to store and/or dynamically generate Web pages in response to end user actions. The website content of the anchor business website may be distributed over several Internet domains, and may be implemented using several servers located at various locations. Of course, a variety of networks, both public and private, may be used as well. The Web pages may be in the form of HTML pages or the like. As can be appreciated, the Internet server module 118 and the database 122 may be used for the second customer rewards program to promote and sell value-bearing instruments for use at participating merchants.

The computer server module 118 may include an interface control system (not shown) and a processor (not shown). The interface control system may be used to provide an interface with the anchor business server 116. The interface control system may include an interface unit (not shown) for receiving at least an identifier of a customer account transmitted during or after a purchase transaction. Furthermore, the interface unit may also be used to receive a purchase transaction amount from a merchant terminal 110 located at a participating merchant. The interface unit may also be used for accessing web pages from database 122.

The interface control system may also include a verification unit (not shown) coupled to the interface unit for verifying a customer's enrollment in the customer rewards program from the identifier received by the interface unit. Additionally, the interface control system may include a qualification unit (not shown) coupled to the interface unit for controlling the transfer and accumulation of dollar amount, cash value or credit points in the customer account. The qualification may be based at least in part on a purchase of a product from a participating merchant and the transfer of customer's identifier encoded in the rewards card.

The processor may be used to process applications selected by a customer or merchant, for example, computing the total dollar amount, cash value or credit points accrued in a customer account. In one embodiment, the processor may be configured to receive at least the identifier and the purchase transaction amount from a merchant terminal 110 via the interface control system. The identifier is transmitted by the merchant terminal 110 in connection with a purchase transaction at a participating merchant. The processor may be configured to verify a customer's membership in the customer rewards program by comparing the transmitted identifier with customer records in database 124. The processor may also be configured to transfer an award, such as a dollar amount, a cash value or a credit point, associated with the purchase transaction amount to the customer account, and process a customer's directive for redeeming the award for use at the anchor business.

As can be appreciated, the processor may further be configured to accumulate, in the customer account, additional awards associated with other purchase transactions amounts. The processor may also be configured to charge or debit the participating merchant a certain percentage of the purchase transaction amount. The award may be a fraction of the certain percentage charged to the participating merchant.

In one embodiment of the second customer rewards program, the database 122 may be used for storing a promotional program for the one of the plurality of participating merchants. The promotional program may offer a value-bearing instrument with a face value greater than its sale value and may be used at one of the plurality of participating merchants. In this embodiment, the processor may be configured to provide the promotional program through the anchor business website, and to receive a request code to purchase the value-bearing instrument from customer computers 102, 106. The processor may also be configured to receive an election of the one of the plurality of participating merchants from the anchor business website. Additionally, the processor may be configured to receive an election of the face value for the value-bearing instrument.

The anchor business server 116 may include an account manager application module 120. The account manager application module 120 may be used to handle customer accounts. The customer account may be used to accumulate dollar amount cash value or credit points earned from a purchase transaction, for example, from dining at a participating restaurant.

The database 122, 124 can be implemented in a machine-readable medium, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. The database 122, 124 may be used to store, arrange and retrieve data.

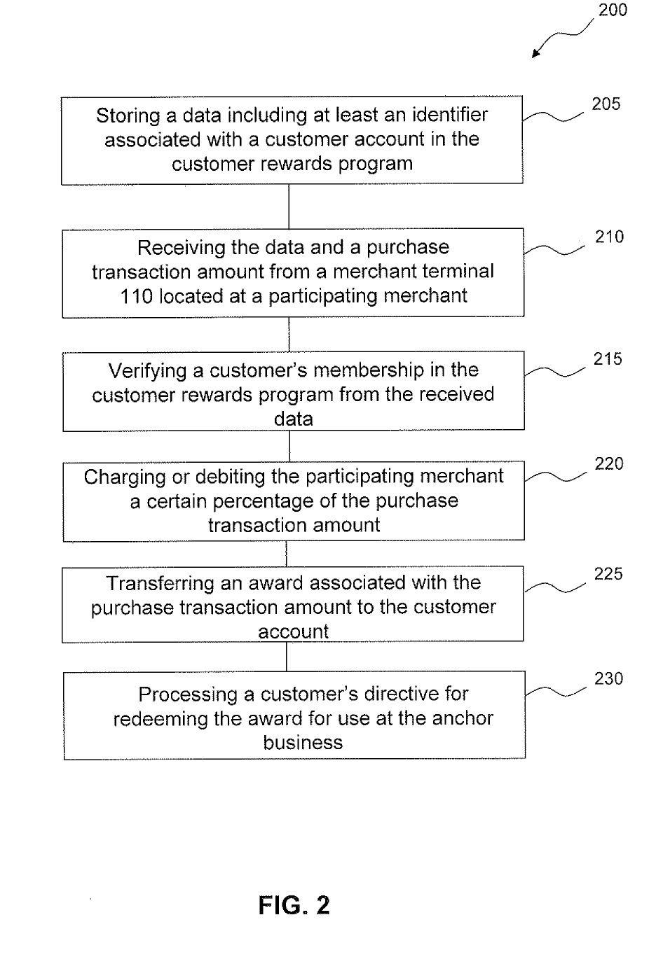

FIG. 2 is an exemplary flowchart 200 outlining the operation of an anchor business server 116 for promoting customer loyalty to an anchor business, according to one embodiment of the present disclosure. The server 116 may be configured to store a data including at least an identifier associated with a customer account in the customer rewards program (205). The server 116 may also be configured to receive the data and a purchase transaction amount from merchant terminal 110 located at one of the plurality of participating merchants (210). In one embodiment, the anchor business server 116 may verify a customer's membership in the customer rewards program from the received data (215). The anchor business server 116 may also charge or debit the one of the plurality of participating merchants a certain percentage of the purchase transaction amount (220). Next, the server 116 may transfer an award associated with the purchase transaction amount to the customer account (225). The award may be a fraction of the certain percentage charged to the one of the plurality of participating merchants. The award may be a dollar amount, a cash value and a credit point. In one embodiment, the server 116 may also process a customer's directive for redeeming the award for use at the anchor business (230).

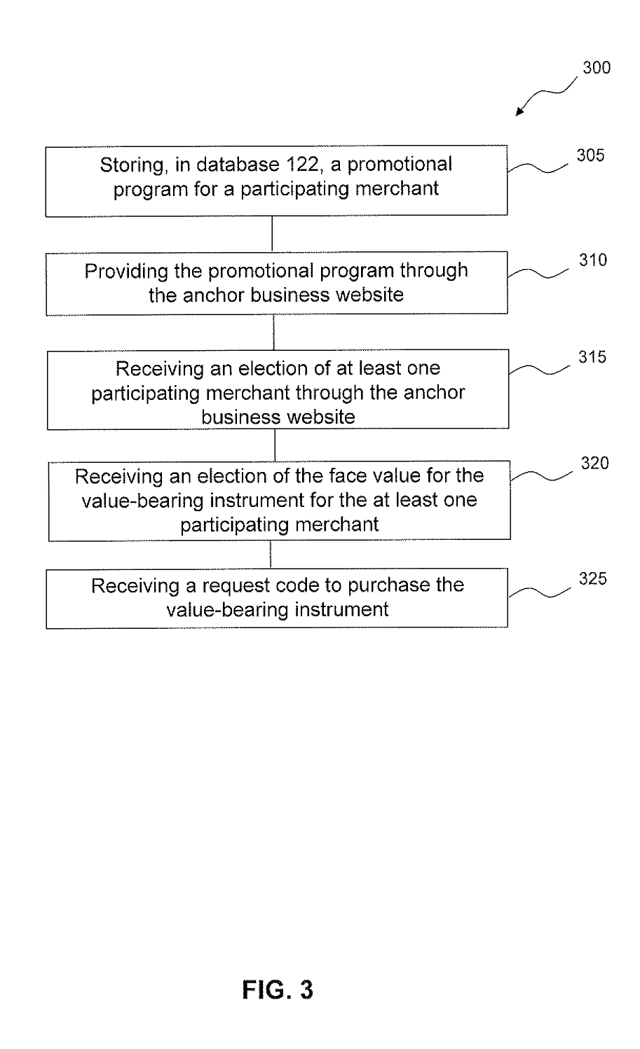

FIG. 3 is an exemplary flowchart 300 outlining the operation of an anchor business server 116 for providing promotional programs of participating merchants within a certain geographical region from an anchor business, according to an embodiment of the present disclosure. The anchor business server 116 may store, in database 122, a promotional program for at least one participating merchant (305). The promotional program offering a value-bearing instrument, such as a gift certificate, with a face value greater than its sale value. The value-bearing instrument may be used at the at least one participating merchant. The anchor business server 116 may also be configured to provide the promotional program through the anchor business website (310). The anchor business server 116 may receive an election of the at least one participating merchant through the anchor business website (315) and/or receive an election of the face value for the value-bearing instrument (320). Next, the anchor business server 116 may receive a request code to purchase the value-bearing instrument (325). In one embodiment, the anchor business server 116 may display a printable certificate for use at the selected participating merchant. In another embodiment, the anchor business server 116 may trigger a mailing request of the value-bearing instrument, such as a discount card, to the customer, and for use at the selected participating merchant.

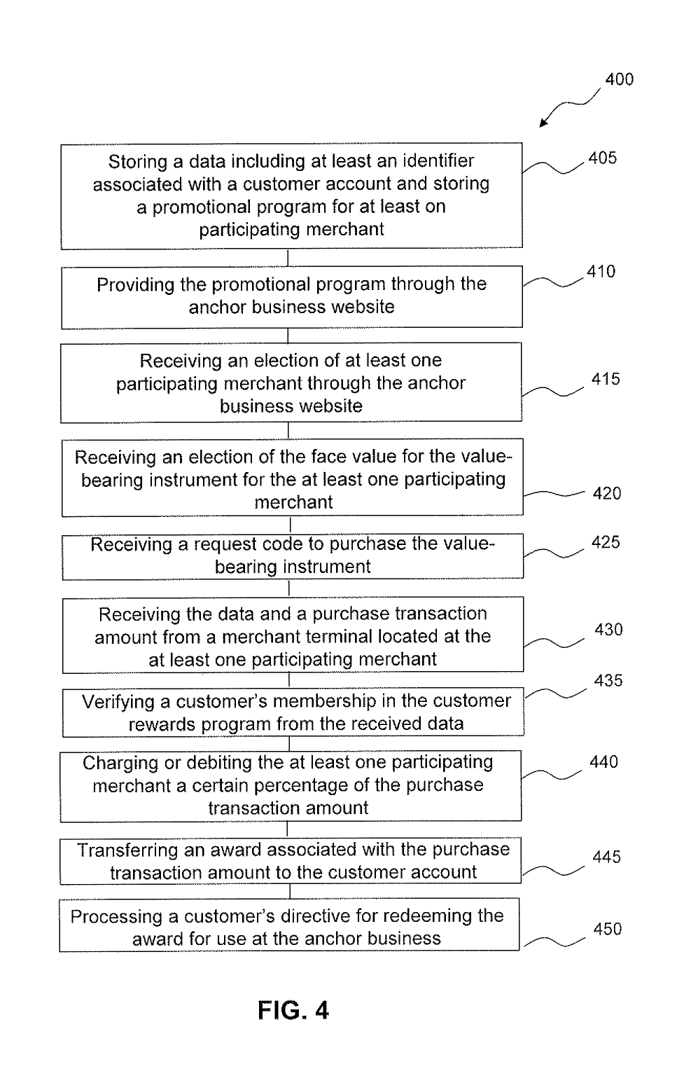

FIG. 4 is an exemplary flowchart 400 outlining the operation of an anchor business server 116 for promoting customer loyalty to an anchor business while providing promotional programs of participating merchants within a certain geographical region from the anchor business. The server 116 may be configured to provide promotional program through the anchor business website and transfer an award associated with a purchase transaction amount to the customer account. The server 116 may store a data including at least an identifier associated with a customer account in the customer rewards program and store a promotional program for at least one participating merchant (405). The promotional program offering a value-bearing instrument with a face value greater than its sale value. The value-bearing instrument may be used at the at least one participating merchant. The anchor business server 116 may be configured to provide the promotional program through the anchor business website (410). The anchor business server 116 may receive an election of the at least one participating merchant through the anchor business website (415) and/or receive an election of the face value for the value-bearing instrument (420). Next, the anchor business server 116 may receive a request code to purchase the value-bearing instrument (425).

As can be appreciated by a person skilled in the art, an award associated with the purchase transaction of the value-bearing instrument may then be transferred to the customer account and is redeemable at the anchor business.

Upon receiving or printing the value-bearing instrument, the customer may present the value-bearing instrument to the selected participating merchant for discount on a purchase transaction amount. The customer may also present his/her rewards card for receiving an award associated with the purchase transaction amount to the customer account.

The server 116 may receive the data and a purchase transaction amount from merchant terminal 110 located at the selected participating merchant (430). In one embodiment, the anchor business server 116 may verify a customer's membership in the customer rewards program from the received data (435). The anchor business server 116 may also charge or debit the participating merchant a certain percentage of the purchase transaction amount (440). Next, the server 116 may transfer an award associated with the purchase transaction amount to the customer account (445). Finally, the server 116 may process a customer's directive for redeeming the award for use at the anchor business (450).

As can be appreciated, a customer may buy a ‘$50 certificate’ from the anchor business website for $18. The customer may make a $100 purchase at the participating merchant, present the ‘$50 certificate’ and pay $50 with cash, check or credit card. The customer would, in this example, realize an immediate savings of $34. In one embodiment, 10% of the purchase transaction amount may be deducted from the participating merchant (i.e. $10), in which case a fraction is transferred to the customer account (i.e. $5) and the remainder is charged as an administration fee (i.e. $5). Hence, the customer realizes an additional $5, in this example, that can be redeemed at the anchor business.

As can be envisioned by a person skilled in the art, the systems, methods and machine-readable mediums may be used to promote customer loyalty to an anchor business within a certain geographical region from a plurality of participating merchants. Although the present invention has been described and illustrated in detail, it is clearly understood that the same is by way of illustration and example only and is not to be taken by way of limitation, the spirit and scope of the present invention being limited by the terms of the appended claims and their equivalents.

With the growth of the Internet, a number of merchants now have a significant online presence and alternative embodiments of the present invention contemplate value-bearing instruments redeemable via an online transaction. Thus, a value-bearing instrument may be redeemed at a “bricks and mortar” merchant or at an online merchant. For merchants having both a physical and an online presence, the value-bearing instrument may be redeemed at either location.

It should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all references listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept. In this regard it should be understood that for practical reasons and so as to avoid adding potentially hundreds of claims, the applicant has presented claims with initial dependencies only.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities, one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible.

While the method has been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A computer-implemented method for promoting customer loyalty in a customer rewards program to an anchor business within a certain geographical region from a plurality of participating merchants, the method comprising:
storing a data including at least an identifier associated with a customer account in the customer rewards program;
receiving the data and a purchase transaction amount from a merchant terminal located at one of the plurality of participating merchants;
verifying a customer's membership in the customer rewards program from the received data;
transferring an award associated with the purchase transaction amount to the customer account; and
processing a customer's directive for redeeming the award for use at the anchor business.

2. The computer-implemented method of claim 1, wherein the award is selected from a group consisting of a dollar amount, a cash value and a credit point.

3. The computer-implemented method of claim 1, further comprising accumulating, in the customer account, additional awards associated with other purchase transactions amounts.

4. The computer-implemented method of claim 1, wherein the certain geographical region is at least about 1 mile to about 5 mile radius around the anchor business.

5. The computer-implemented method of claim 1, wherein the plurality of participating merchants are promoted at the anchor business through the customer rewards program.

6. The computer-implemented method of claim 1, further comprising charging the one of the plurality of participating merchants a certain percentage of the purchase transaction amount, after the step of receiving the data and a purchase transaction amount from a merchant terminal.

7. The computer-implemented method of claim 6, wherein the award is a fraction of the certain percentage charged to the one of the plurality of participating merchants.

8. The computer-implemented method of claim 1, further comprising:
storing, in an anchor business database, a promotional program for the one of the plurality of participating merchants, the promotional program offering a value-bearing instrument with a face value greater than its sale value, the value-bearing instrument for use at the one of the plurality of participating merchants;
providing the promotional program through an anchor business website; and
receiving a request code to purchase the value-bearing instrument.

9. The computer-implemented method of claim 8, further comprising receiving an election of the one of the plurality of participating merchants through the anchor business website.

10. The computer-implemented method of claim 8, further comprising receiving an election of the face value for the value-bearing instrument prior to the step of receiving a request code to purchase the value-bearing instrument.

11. A system for promoting customer loyalty in a customer rewards program to an anchor business within a certain geographical region from a plurality of participating merchants, the system comprising:
a memory for storing a data including at least an identifier associated with a customer account in the customer rewards program; and
a processor configured to:
receive the data and a purchase transaction amount from a merchant terminal located at one of the plurality of participating merchants;
verify a customer's membership in the customer rewards program from the received data;
transfer an award associated with the purchase transaction amount to the customer account; and
process a customer's directive for redeeming the award for use at the anchor business.

12. The system of claim 11, wherein the award is selected from a group consisting of a dollar amount, a cash value and a credit point.

13. The system of claim 11, wherein the processor is further configured to accumulate, in the customer account, additional awards associated with other purchase transactions amounts.

14. The system of claim 11, wherein the certain geographical region is at least about 1 mile to about 5 mile radius around the anchor business.

15. The system of claim 11, wherein the plurality of participating merchants are promoted at the anchor business through the customer rewards program.

16. The system of claim 11, wherein the processor is further configured to debit the one of the plurality of participating merchants a certain percentage of the purchase transaction amount.

17. The system of claim 16, wherein the award is a fraction of the certain percentage charged to the one of the plurality of participating merchants.

18. The system of claim 11, further comprising:
an anchor business database for storing a promotional program for the one of the plurality of participating merchants, the promotional program offering a value-bearing instrument with a face value greater than its sale value, the value-bearing instrument for use at the one of the plurality of participating merchants;
wherein the processor is further configured to provide the promotional program through an anchor business website, and to receive a request code to purchase the value-bearing instrument.

19. The system of claim 18, wherein the processor is further configured to receive an election of the one of the plurality of participating merchants through the anchor business website.

20. The system of claim 18, wherein the processor is further configured to receive an election of the face value for the value-bearing instrument prior to the step of receiving a request code to purchase the value-bearing instrument.

21. A machine-readable medium that provides instructions, which when read by a processor, cause the machine to perform operations comprising:
storing a data including at least an identifier associated with a customer account in the customer rewards program;
storing, in an anchor business database, a promotional program for at least one participating merchant, the promotional program offering a value-bearing instrument with a face value greater than its sale value, the value-bearing instrument for use at the at least one participating merchant;
receiving the data from a customer computer through an anchor business website;
verifying a customer's membership in the customer rewards program from the received data;
providing the promotional program through the anchor business website;
receiving a request code to purchase the value-bearing instrument;
transferring an award associated with the purchase of the value-bearing instrument to the customer account; and
processing a customer's directive for redeeming the award for use at the anchor business.

22. The machine-readable medium of claim 21, wherein the award is selected from a group consisting of a dollar amount, a cash value and a credit point.

23. The machine-readable medium of claim 21, further comprising accumulating, in the customer account, additional awards associated with other purchase transactions amounts.

24. The machine-readable medium of claim 21, further comprising receiving an election of the one of the at least one participating merchant through the anchor business website.

25. The machine-readable medium of claim 21, further comprising receiving an election of the face value for the value-bearing instrument prior to the step of receiving a request code to purchase the value-bearing instrument.
